(19) United States
(12) Patent Application Publication
(10) Pub. No.: US 2019/0024550 A1
(43) Pub. Date: Jan. 24, 2019

(54) CONDENSATE SEPARATOR

(71) Applicant: Mahle International GmbH, Stuttgart (DE)

(72) Inventors: Jorge Curras-Guede, Ostifldern (DE); David Mercader Quintana, Ludwigsburg (DE); Thomas Hohenschlaeger, Stuttgart (DE); Fabian Kees, Karlsruhe (DE)

(21) Appl. No.: 16/037,907

(22) Filed: Jul. 17, 2018

(30) Foreign Application Priority Data
Jul. 18, 2017 (DE) 102017212268.4
Jul. 9, 2018 (DE) 102018211300.9

(51) Int. Cl. F01N 3/00; F02M 26/35; F02M 26/23; B04C 3/06; B01D 45/16

(52) U.S. Cl. CPC F01N 3/005; F02M 26/35; F02B 29/0468; B04C 3/06; B01D 45/16; F02M 26/23

(57) ABSTRACT

A condensate separator for separating condensate from a gas stream, the condensate separator may include a housing having a condensate drain at a bottom end, a swirl generator provided at an inlet end of the housing, the swirl generator placing the gas stream in a rotational movement, and an impact element situated downstream from the swirl generator.

### CROSS-REFERENCE TO RELATED APPLICATIONS

This application claims priority to German Patent Application No. DE 10 2017 212 268.4, filed on Jul. 18, 2017, and German Patent Application No. DE 10 2018 211 300.9, filed on Jul. 9, 2018, the contents of both of which are incorporated herein by reference in their entireties.

### TECHNICAL FIELD

The invention relates to a condensate separator. The invention furthermore relates to a heat exchanger with such a condensate separator.

### BACKGROUND

From DE 10 2005 050 133 A1 there is known an arrangement, especially a turbocharger arrangement of a motor vehicle, with an internal combustion engine and exhaust gas recirculation, wherein the arrangement has an exhaust gas cooler and a charge air cooler for cooling of recirculated exhaust gas and/or charge air as well as a compressor for compressing the charge air and at least one condensate separator.

From U.S. Pat. No. 6,748,741 B2 there is known a charge air condensation separating system for an engine with turbocharger, especially for engines with exhaust gas recirculation, wherein the charge air condensation separating system has a turbocharger with a compressor, which cools the charge air with a charge cooler. A charge air supply duct is connected to an outlet of the charge air cooler, wherein a toroidal trap with an annular inlet is arranged in the charge air supply duct with a sump for collecting of condensate, integrated in the toroidal trap. A drain line for taking away condensate from the sump and ejecting the condensate into the atmosphere is connected to the toroidal trap and a pump, or another device for overcoming the pressure difference in the drain line, is used in certain embodiments.

From U.S. Pat. No. 3,817,221 A there is known a device for draining of condensation liquid from the exhaust gases of an internal combustion engine, prior to the recirculation of a portion of these exhaust gases to the internal combustion engine. At a suitable position of the exhaust gas line there is arranged at least one device with which the liquid formed during the condensation of the moisture from the exhaust gases is taken up and directed through pipelines to the intake of the internal combustion engine. This liquid is recirculated in a combustion chamber and aspirated by the partial vacuum of air into the combustion chamber.

From U.S. Pat. No. 4,696,279 A there is known a system for a combustion control system for an internal combustion engine with exhaust gas recirculation line, wherein a decanter centrifuge is arranged in the exhaust gas recirculation line, which separates condensate and small particles from the exhaust gas stream.

From WO 2016/020162 A1 there is known a cooler for cooling a gas flow with a cooler block, having one gas pathway carrying the gas flow and one coolant pathway carrying a flow of coolant. The two pathways are separated in terms of media, yet thermally coupled together, and a liquid separator is situated downstream of the cooler block, relative to the direction of the gas flow, in a cooler housing. A condensate drain by which the condensate separated at the liquid separator can drain from the cooler housing is situated at a distance from the cooler block, as with the liquid separator.

In internal combustion engines, exhaust gas condensates are generated, being unavoidable during operation. Exhaust gas condensates in components situated in the intake stream after the heat exchanger may lead to corrosion and misfiring in the internal combustion engine. This can be avoided by reducing the condensate carried along by the exhaust gas and entering the intake line.

The drawback of the prior art according to WO 2016/020162 A1 is in particular that the separation principles have a relatively low efficiency. If the separation of the condensate occurs in the exhaust gas recirculation path by means of a grid, there will also occur a fouling and sooting of the grid, having negative influence on the pressure loss in the exhaust gas recirculation system.

The drawback to U.S. Pat. No. 4,696,279 A is that this is only effective for the condensate separation in small exhaust gas quantities and is disadvantageous in terms of costs and design space required, since the decanter centrifuge acting as the separator is an add-on part, not integrated in the heat exchanger.

One problem which the present invention proposes to solve is to indicate new ways for condensate separators to separate condensate from a gas stream.

This problem is solved according to the invention by the subject matter of the independent claims. Advantageous embodiments are the subject matter of the dependent claims.

### SUMMARY

The present invention is based on the general idea of achieving a design space-optimized and at the same time improved condensate separation in that a condensate-laden gas stream at first undergoes a swirling acceleration and then is guided onto an impact element, for which purpose there are arranged at the inlet end on the housing of a condensate separator a swirl generator and downstream from the swirl generator an impact element. The gas is always guided in linear manner in one direction. Thanks to the integration of the condensate separator in an exhaust gas return line, directly on the heat exchanger, it is possible to separate the condensate with no additional components, which is advantageous in terms of costs. The housing of the condensate separator has herein a connection flange at the point of entry of the exhaust gas stream into the condensate separator for the attachment of the condensate separator to a heat exchanger. Moreover, it is advantageous that no additional axis is used for a diverting of the exhaust gas stream from the linear direction, so that the condensate separator can have a space-optimized design. By doing without a diverting of the exhaust gas stream, moreover, only slight pressure losses are generated in the exhaust gas stream.

In one preferred embodiment, a housing of the condensate separator has at the inlet end a funnel element directed into the housing, wherein the swirl generator is situated downstream from the funnel element. In this case, the funnel element acts as a kind of nozzle and accelerates the gas stream. By increasing the flow velocity at the funnel element, the following condensate separation is also improved.

The separated condensate may be drained by at least one condensate drain in the bottom of the housing of the condensate separator. The outlet pipe is located at the opposite side of the connection flange of the heat exchanger and may protrude into the housing of the condensate separator. The length of the outlet pipe and the distance from this pipe to the impact element may act as set points for the condensate separation rate and the pressure loss in the exhaust gas stream. By mounting a cone-shaped diverting element on the swirl generator, an improvement and optimization of the separation rate can be achieved in regard to the diverting of the condensate from the main flow in the direction of the walls of the housing of the condensate separator.

In another preferred embodiment, the swirl generator is configured as an insert element. The swirl generator may be combined with the impact element, which is situated downstream from the swirl generator, so that the diverting and the separating of the condensate from the gas stream occurs in a component with a short structure. In addition, the arrangement may have a swirl sleeve. The swirl sleeve should prevent condensate already separated from being entrained again by the incoming exhaust gas stream, so that the separation rate can be boosted. The swirl sleeve may be fastened by a flange between the connection flange of the heat exchanger and the housing of the condensate separator, preferably by clamping. Moreover, the funnel element may be eliminated, for which the swirl generator with the combined impact element has a larger diameter.

Bypass openings may be provided between the swirl generator and the connection flange of the heat exchanger, which are preferably configured as slots. The bypass openings serve for transporting away the condensate separated by the swirl generator. The bypass openings may lead to an improved flow of the condensate through the condensate separator and thus to an improved efficiency of the condensate separator. It is also possible to use only one large swirl generator with no integrated impact element, in which case the impact element can be entirely eliminated. Moreover, the impact element may be arranged downstream from the swirl generator.

The integration of a cone-shaped diverting element directly in the swirl generator may lead to an improvement in the diverting of the condensate from the exhaust gas stream in the direction of the walls of the housing of the condensate separator and thus to an optimization of the separation rate of the condensate separator. The integration of both components in a single component is advantageous in terms of space needed in the design space and the manufacturing costs.

In another preferred embodiment, the swirl generator is configured as a web-shaped holder arranged on the connection flange of the heat exchanger, holding a cone-shaped diverting element at its cone tip. The web-shaped holder holds the cone-shaped diverting element in the middle of the exhaust gas stream, the cone tip of the diverting element being directed against the flow direction of the exhaust gas stream. The simple geometry of the cone-shaped diverting element enables a favourable production as compared to other more complex geometries.

In one advantageous modification of the solution according to the invention, a flow control contour is arranged upstream from the condensate drain in the flow direction of the gas stream, such as a spoiler, a ramp or a wing, which diverts the gas stream across the condensate drain. Of course, the flow control element may also take other forms, for example, being configured as an annular bulge partly enclosing the condensate drain. Thanks to such a flow control contour, the separated quantity of condensate may be boosted fourfold.

Other important features and advantages of the invention will emerge from the dependent claims, from the drawings, and from the description of the corresponding figures with the aid of the drawings.

Of course, the above-mentioned features and the following ones yet to be discussed may be used not only in the respective indicated combination, but also in other combinations or standing alone, without leaving the scope of the present invention.

Preferred exemplary embodiments of the invention are represented in the drawings and shall be explained more closely in the following description, where the same reference numbers pertain to the same or similar or functionally identical components.

### BRIEF DESCRIPTION OF THE DRAWINGS

There are shown, each time schematically

FIG. 1 is a view of a condensate separator according to the invention with a funnel element,

FIG. 2 is a view of another embodiment of a condensate separator according to the invention,

FIG. 3 is a view of a condensate separator according to the invention with a swirl sleeve, where an outlet pipe protrudes into the housing,

FIG. 4 is a view of a condensate separator according to the invention, in which a cone-shaped diverting element is fastened to a holder,

FIG. 5 is an exploded view of a condensate separator according to the invention,

FIG. 6 is a representation of the condensate separator shown in FIG. 5 in the installed state,

FIG. 7 is a cross-sectional representation of the condensate separator per FIGS. 5 and 6,

FIG. 8 a partly sectional view of the condensate separator with a flow control contour.

### DETAILED DESCRIPTION

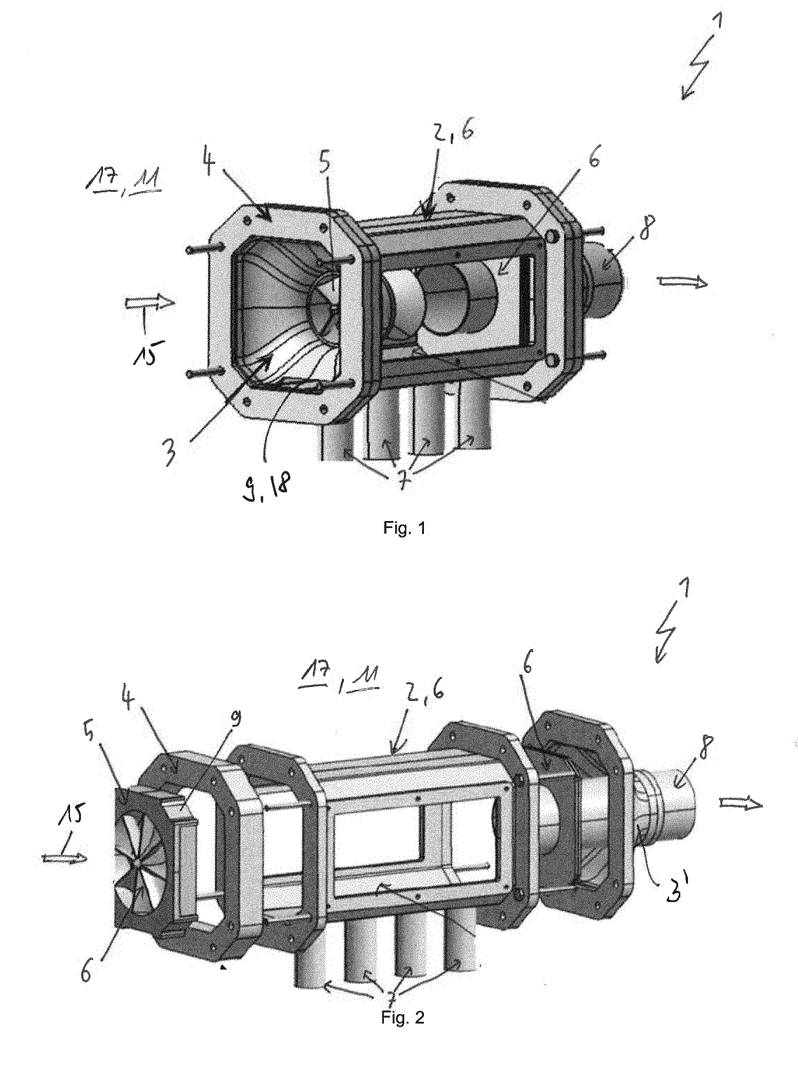

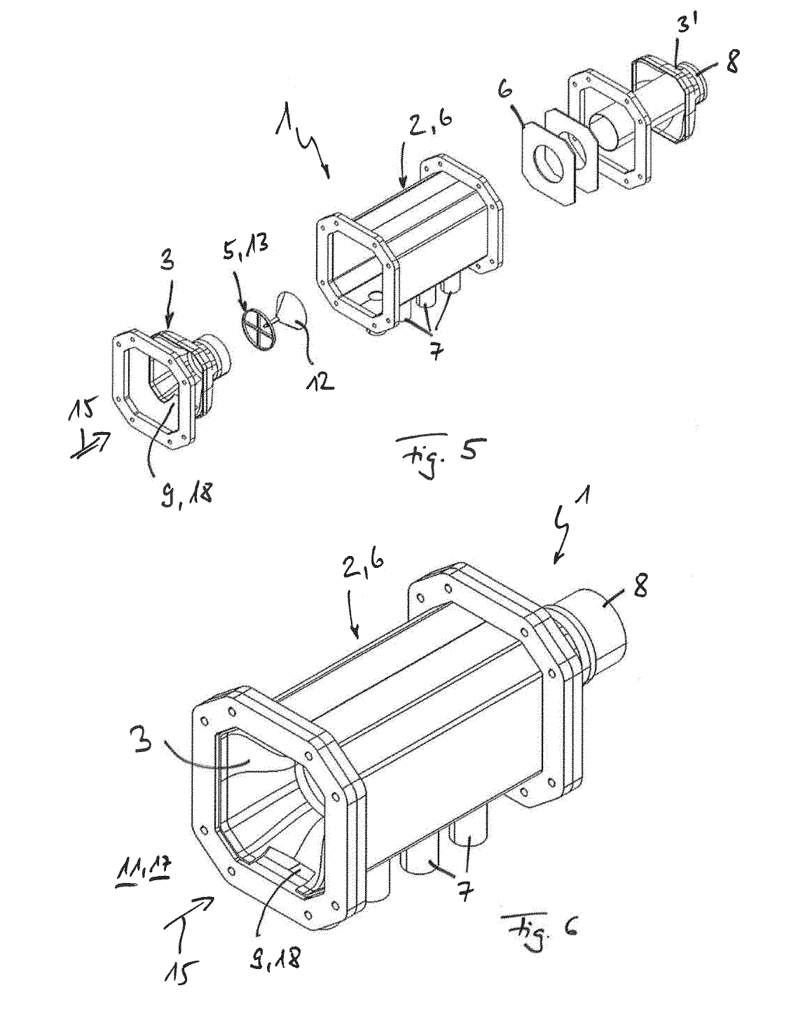

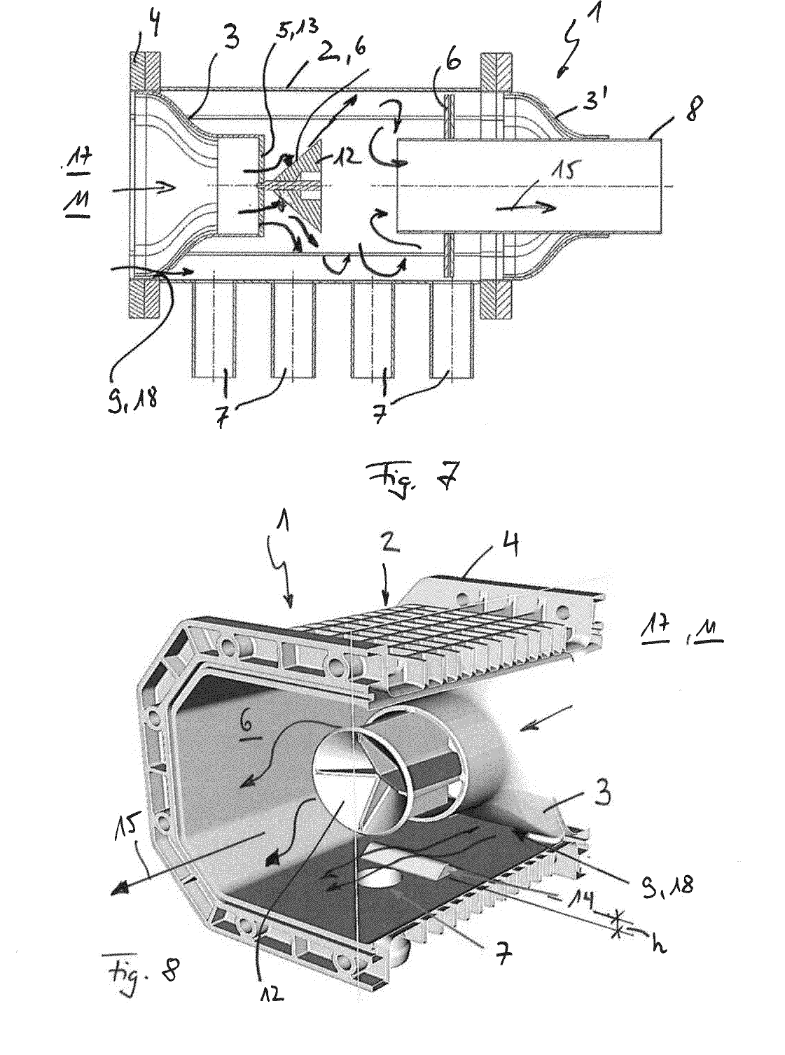

FIG. 1 as well as 5 to 8 show one possible layout of a condensate separator 1 according to the invention, in which a funnel element 3 pointing into the housing 2 of the condensate separator 1 is arranged between a connection flange 4 for attachment to a heat exchanger 17 and a swirl generator 5. Such a condensate separator 1 may be used for example in concert with a heat exchanger 17 of an internal combustion engine 11. Looking at FIG. 1 as well as FIGS. 5 to 8, the exhaust gas stream flows through the condensate separator 1 always in the direction of the arrow. The swirl generator 5 is situated at the outlet of the funnel element 3, wherein the funnel element 3 is connected at its inflow end to the connection flange 4. The exhaust gas stream flowing into the condensate separator 1 at the connection flange 4 is accelerated by the funnel element 3, which acts as a kind of nozzle, and is placed in a swirling motion by the swirl generator 5. This intensifies the diverting of the condensate from the exhaust gas stream in the direction of the housing 2, against which the condensate from the exhaust gas stream strikes and is separated. The condensate strikes the wall of the housing 2 and is separated from the exhaust gas stream, where the housing 2 of the condensate separator 1 serves as the impact element 6 (see FIGS. 1 to 8). The separated condensate is drained by the force of gravity acting on the condensate through at least one of the condensate drains 7 from the condensate separator 1 (also see FIGS. 2 to 4). Of course, in all the embodiments of the condensate separator 1 according to the invention more or fewer condensate drains 7 than those shown in FIGS. 1 to 7 may be provided. The exhaust gas stream enters the condensate separator 1 at the connection flange 4 and flows through the housing 2 of the condensate separator 1, emerging after the condensate separation on the walls of the housing 2 through an outlet pipe 8 from the condensate separator 1, the outlet pipe 8 being situated at the opposite end of the condensate separator 1 (see FIGS. 1 to 7).

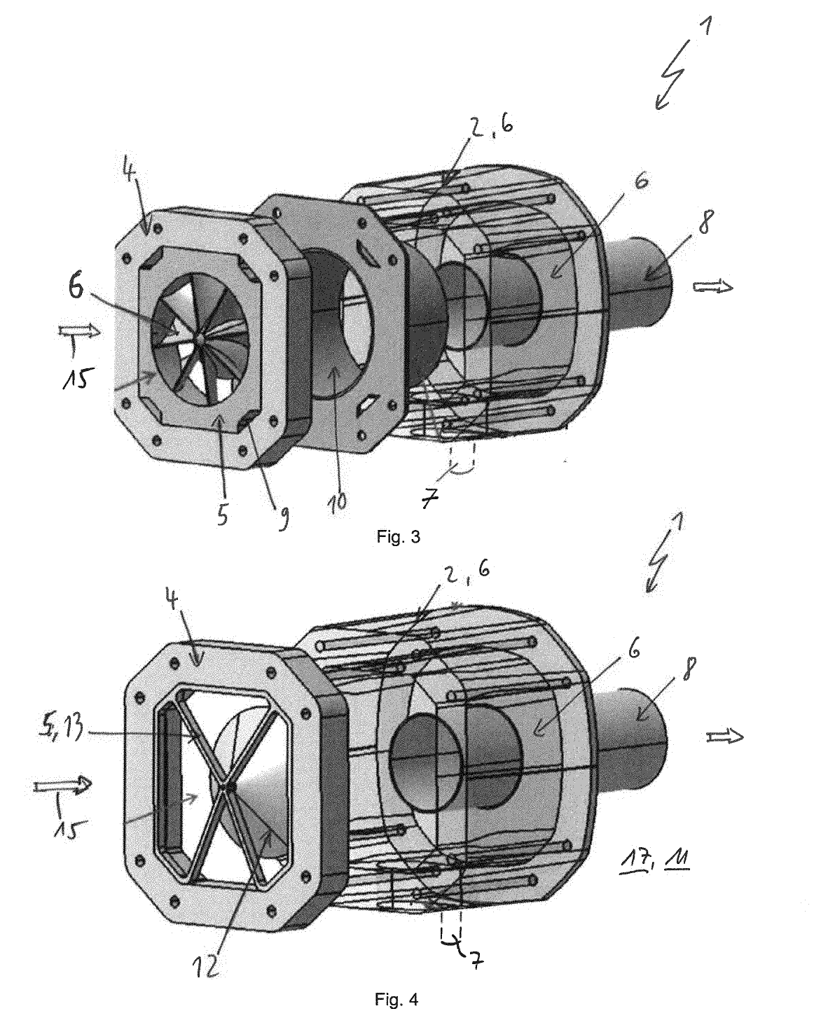

FIG. 2 shows the condensate separator 1 according to the invention in an alternative embodiment, in which no funnel element 3 is used to accelerate the exhaust gas stream. Considering the condensate separator 1 in FIG. 2, one may notice that the impact element 6 is directly integrated in the swirl generator 5, so that the distance from the connection flange 4 of the heat exchanger 17 to the outlet pipe 8 is reduced. This enables an optimal utilization of the available design space. The impact element 6 and the swirl generator 5 in this embodiment have a larger diameter than in the embodiment described in FIG. 1. Of course, the impact element 6 may also be formed by the housing 2. In this case, only the swirl generator 5 is arranged on the connection flange 4. Bypass openings 9 (see FIGS. 2 and 3) are formed on the swirl generator 5, being preferably designed as slots. Moreover, it is possible to arrange the impact element 6 downstream from the swirl generator 5. The bypass openings 9 improve the flow of condensate, so that the efficiency of the condensate separator 1 can also be boosted, since already separated condensate in this embodiment arrives by these bypass openings 9 in the condensate separator 1 and then can be drained from the condensate separator 1 without striking against an impact element 6. In this embodiment, the housing 2 of the condensate separator 1 serves as a second or alternative impact element 6 (see FIGS. 2 and 3). At the opposite end of the condensate separator 1, looking from the connection flange 4 of the heat exchanger 17, there is situated the outlet pipe 8 (see FIGS. 1 to 7) for the exhaust gas stream freed of condensate. The condensate separated by the impact element 6 or the bypass openings 9 from the exhaust gas stream is drained by force of gravity through at least one of the four condensate drains 7 shown in FIG. 2 (cf. FIG. 3, 4) from the condensate separator 1.

FIG. 3 shows another possible layout of the condensate separator 1 according to the invention, in which the impact element 6 is integrated directly in the swirl generator 5, the impact element 6 and the swirl generator 5 being arranged on the connection flange 4 of the heat exchanger. The swirl generator 5 has bypass openings 9 (see FIGS. 2 to 3), which are preferably designed as slots. On the connection flange 4 of the heat exchanger 17 there is arranged a swirl sleeve 10. The swirl sleeve 10 boosts the efficiency of the condensate separator 1, since it prevents condensate already separated by the bypass openings 9 from being again entrained by the exhaust gas stream, instead of being drained by at least one condensate drain 7 (see FIGS. 1 to 7) from the condensate separator 1. The swirl sleeve 10 also serves here as an impact element 6.

At the opposite end of the condensate separator 1, looking from the connection flange 4, there is situated the outlet pipe 8 (see FIGS. 1 to 7) for the exhaust gas stream freed of condensate, which in this embodiment protrudes into the housing 2 (see FIGS. 3 to 4), the housing 2 of the condensate separator 1 acting as an impact element 6 (see FIGS. 1 to 4). The length of the outlet pipe 8 by which the outlet pipe 8 protrudes into the housing 2 of the condensate separator 1 serves as a setpoint for the condensate separation rate of the condensate separator 1 and/or for the size of the pressure loss in the exhaust gas stream. The more the outlet pipe 8 protrudes in the direction of the connection flange 4 into the housing 2, the lower the pressure loss in the exhaust gas stream, but also the lower the efficiency of the condensate separator 1. In other words: the smaller the distance between the end of the outlet pipe 8 protruding into the housing 2 and the connection flange 4, the lower the separation rate of the condensate separator 1 and the lower the pressure loss in the exhaust gas stream (see FIGS. 3 and 4).

According to FIGS. 4 to 7, a condensate separator 1 according to the invention has a cone-shaped diverting element 12, which is held by the swirl generator 5, being designed in this embodiment as a web-shaped holder 13. The web-shaped holder 13, serving as the swirl generator 5, holds the cone-shaped diverting element 12 in the middle of the exhaust gas stream, which ensures an optimal diverting of the condensate from the exhaust gas stream in the direction of the walls of the housing 2, serving as the impact element 6, for the condensate separation rate of the condensate separator 1. Further considering FIGS. 4 to 7, one may notice that the cone-shaped diverting element 12 is held by the web-shaped holder 13 in such a way that the tip of the cone of the cone-shaped diverting element 12 is pointing in the direction of the swirl generator 5. The tip of the cone-shaped diverting element 12 is thus pointing against the flow direction of the exhaust gas stream. Condensate is separated at the walls of the housing 2 of the condensate separator 1 from the exhaust gas stream, the separated condensate collecting by force of gravity on the bottom of the housing 2 and being drained by at least one condensate drain 7 from the condensate separator 1. The swirl generator 5 configured as a holder 13 here is more economical than the one shown in FIG. 3, for example.

Since the cone-shaped diverting element 12 has a simple geometry, the production costs for the cone-shaped diverting element 12 can be kept low. At the opposite end of the condensate separator 1, looking from the connection flange 4 of the heat exchanger 17, there is located the outlet pipe 8 for the exhaust gas stream, which also in this embodiment protrudes into the housing 2 in the direction of the connection flange 4, the length of the outlet pipe 8 by which the outlet pipe 8 protrudes into the housing 2 serving as a setpoint for the condensate separation rate of the condensate separator 1 and for the pressure loss in the exhaust gas stream (see FIGS. 3 and 4). The outlet pipe 8 may be held here by another funnel element 3′ and additionally by the impact element 6.

In the embodiments shown in FIGS. 5 to 8, the funnel element 3 has a cut-out 18 serving as a bypass opening 9, by which the draining of the condensate into the condensate drains 7 is assisted by the bypass flow passing through this. In the flow direction 15 of the gas stream upstream from the condensate drain 7 per FIG. 8 there is situated a flow control contour 14, which guides the gas stream across the condensate drain 7. The flow control contour 14 is configured as a spoiler, a ramp, or a wing. A height h of the flow control contour 14 is preferably between 3.0 mm and 20.0 mm, especially between 4.5 mm and 6.0 mm. A distance between the flow control contour 14 and the condensate drain 7 is between 0 mm and 55 mm. Thanks to such a flow control contour 14, the separated quantity of condensate can be increased fourfold. The flow control element 14 herein may of course also take on other forms, such as an annular bulge which partly encloses the condensate drain 7, in particular, even one which rests tangentially against it.

1. A condensate separator for separating condensate from a gas stream, comprising:
a housing having a condensate drain at a bottom end;
a swirl generator provided at an inlet end of the housing, the swirl generator placing the gas stream in a rotational movement; and
an impact element situated downstream from the swirl generator.

2. The condensate separator according to claim 1, wherein the housing has at the inlet end a funnel element directed into the housing, and wherein at least one of:
the swirl generator is situated downstream from the funnel element; and
the funnel element has a cut-out serving as a bypass opening.

3. The condensate separator according to claim 1, wherein the housing has at the inlet end a connection flange for attachment to a heat exchanger, wherein the swirl generator is situated or held in the connection flange and is configured as an insert element.

4. The condensate separator according to claim 3, wherein bypass openings are provided between the swirl generator and the connection flange.

5. The condensate separator according to claim 3, wherein the impact element is configured as a swirl sleeve.

6. The condensate separator according to claim 1, wherein the housing has at the inlet end a connection flange for attachment to a heat exchanger, the swirl generator is configured as a holder that holds a cone-shaped diverting element at a cone tip thereof, and the holder is arranged in the connection flange.

7. The condensate separator according to claim 6, wherein the cone tip of the cone-shaped diverting element is directed against a flow direction of the gas stream.

8. The condensate separator according to claim 1, wherein an outlet pipe is provided at an outlet end of the housing, the outlet pipe protruding into the housing, the housing forming the impact element.

9. A heat exchanger comprising a condensate separator for separating condensate from a gas stream, the condensate separator having:
a housing having a condensate drain at a bottom end;
a swirl generator provided at an inlet end of the housing, the swirl generator placing the gas stream in a rotational movement; and
an impact element situated downstream from the swirl generator.

10. The condensate separator according to claim 1, wherein a flow control contour is arranged upstream from the condensate drain in a flow direction of the gas stream, the flow control contour diverting the gas stream across the condensate drain.

11. The condensate separator according to claim 10, wherein the flow control contour is designed as a spoiler or a wing.

12. The heat exchanger according to claim 9, wherein the housing has at the inlet end a funnel element directed into the housing, and wherein at least one of:
the swirl generator is situated downstream from the funnel element; and
the funnel element has a cut-out serving as a bypass opening.

13. The heat exchanger according to claim 9, wherein the housing has at the inlet end a connection flange for attachment to a heat exchanger, wherein the swirl generator is situated or held in the connection flange and is configured as an insert element.

14. The heat exchanger according to claim 13, wherein bypass openings are provided between the swirl generator and the connection flange.

15. The heat exchanger according to claim 13, wherein the impact element is configured as a swirl sleeve.

16. The heat exchanger according to claim 9, wherein the housing has at the inlet end a connection flange for attachment to a heat exchanger, the swirl generator is configured as a holder that holds a cone-shaped diverting element at a cone tip thereof, and the holder is arranged in the connection flange.

17. The heat exchanger according to claim 16, wherein the cone tip of the cone-shaped diverting element is directed against a flow direction of the gas stream.

18. The heat exchanger according to claim 9, wherein an outlet pipe is provided at an outlet end of the housing, the outlet pipe protruding into the housing, the housing forming the impact element.

19. A condensate separator for separating condensate from a gas stream, comprising:
a housing having a condensate drain at a bottom end;
a swirl generator provided at an inlet end of the housing, the swirl generator placing the gas stream in a rotational movement;
an impact element situated downstream from the swirl generator; and
an outlet pipe provided at an outlet end of the housing, the outlet pipe protruding into the housing;
wherein the housing has at the inlet end a connection flange for attachment to a heat exchanger, and a funnel at the inlet end directed into the housing.

20. The condensate separator according to claim 19, wherein the swirl generator is configured as a holder that holds a cone-shaped diverting element at a cone tip thereof, and the holder is arranged in the connection flange.
